(19) United States
(12) Patent Application Publication
(10) Pub. No.: US 2007/0201693 A1
(43) Pub. Date: Aug. 30, 2007

(54) INFORMATION PROCESSING APPARATUS AND INFORMATION PROCESSING METHOD PERFORMING DECODING OR ENCRYPTION

(76) Inventor: Katsuya OHNO, Kokubunji-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/618,178

(22) Filed: Dec. 29, 2006

(30) Foreign Application Priority Data
Feb. 28, 2006 (JP) 2006-051987

(51) Int. Cl. H04N 7/167

(52) U.S. Cl. 380/201

(57) ABSTRACT

An information processing apparatus is provided which processes stream data including, in a non-encrypted region, pointer information designating keys used for decoding of data in an encrypted region of the stream data. In this processing, the apparatus detects change of the pointer information extracted in decoding of the stream data, and generates a decoding key of the stream data on the basis of key generation data, in response to a trigger of agreement between the changed pointer information and information set separately. The method decodes the data in the encrypted region of the stream data by using the generated decoding key.

### CROSS-REFERENCE TO RELATED APPLICATIONS

This application is based upon and claims the benefit of priority from Japanese Patent Application No. 2006-051987, filed Feb. 28, 2006, the entire contents of which are incorporated herein by reference.

### BACKGROUND

1. Field

One embodiment of the invention relates to an information processing apparatus and an information processing method performing decoding of encrypted content, and an information processing apparatus and an information processing method which encrypt content to be protected from unauthorized use (such as illegal copy). In particular, the present invention relates to an information processing apparatus (to be installed in players or recorders having a playback function) and an information processing method which precisely decode stream data of encrypted audio video content (AV content).

2. Description of the Related Art

Recently, various playback apparatuses (playback-only players, recorders having a playback function, or personal computers equipped with a DVD disc drive and playback software) have been developed, which play back AV content stored in disc media such as DVD (Digital Versatile Disc). Stream data stored in DVD discs to be played back by such playback apparatuses are encrypted to prevent copy. To data portions of encrypted stream, adopted mainly is an encryption method based on CSS (Content Scramble System) method.

In the CSS method, when moving image stream data stored in a DVD disc is played back, the playback apparatus performs processing of moving image stream data of a title (AV content or the like) read from the disc, and processing of generating a decoding key to decode the moving image stream data. Specifically, the playback apparatus reads a decoding key corresponding to encrypted data portions, and decodes the encrypted data portions by using the encrypted key. Thereby, the playback apparatus plays back the moving image stream data.

Large-capacity media such as DVD discs may store a plurality of moving image stream data items. In such cases, the playback apparatus needs to prepare decoding keys corresponding to the respective moving image stream data items recorded on the media.

Jpn. Pat. Appln. KOKAI Pub. No. 2005-92830 discloses a computer having a plurality of management units which manage respective identifiers of moving image stream data to be played back. The computer has a function of executing decoding of moving image stream to be played back, by switching to a management unit which manages an identifier corresponding to the identifier included in the moving image stream to be played back. Thereby, the apparatus can continuously play back the moving image stream data to be played back, while the identifier included in the moving image stream data does not change.

An object of the present invention is to achieve precise decoding of encrypted stream data.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram illustrating a configuration of a main part of a first information processing apparatus according to an embodiment.

FIG. 2 is a diagram illustrating an example of stream data to be processed by the configuration of FIG. 1.

FIG. 3 is a diagram illustrating an example of title key management data (key generation data) used in the configuration of FIG. 1.

FIG. 4 is a time chart illustrating an example of a flow of decoding (or encryption) executed by the configuration of FIG. 1.

FIG. 5 is a flowchart illustrating an example of decoding executed by the configuration of FIG. 1.

FIG. 6 is a flowchart illustrating an example of encryption executed by the configuration of FIG. 1.

FIG. 7 is a diagram illustrating an example of an information processing apparatus, in which the configuration of FIG. 1 is incorporated.

FIG. 8 is a diagram illustrating another example of the information processing apparatus, in which the configuration of FIG. 1 is incorporated.

FIG. 9 is a diagram illustrating another example of the information processing apparatus, in which the configuration of FIG. 1 is incorporated.

FIG. 10 is a diagram illustrating an example of an optical disc playback apparatus, in which the configuration of FIG. 1 is incorporated.

### DETAILED DESCRIPTION

Various embodiments according to the invention will be described hereinafter with reference to the accompanying drawings. In general, according to one embodiment of the invention, an information processing apparatus having a processing section, the processing section decoding a stream including non-encrypted pointer information and encrypted data to be decoded by key information designated by the pointer information, the information processing apparatus comprises holding means for holding predetermined set information corresponding to the pointer information of the stream to be input. And storage means for storing key generation data formed of a combination of the pointer information included in the stream and the key information designated by the pointer information, wherein the processing section includes extracting means for extracting the pointer information included in the input stream. First detecting means for detecting change of the pointer information extracted by the extracting means. Second detecting means for detecting that the pointer information, change of which has been detected by the first detecting means, agrees with or corresponds to the set information corresponding to the changed pointer information and held in the holding means. Key generation means for obtaining key information corresponding to the pointer information included in the input stream from the key generation data stored in the storage means, and generating a decoding key, when the second detecting means detects agreement or correspondence between the pointer information and the set information. And decoding means for detecting the encrypted data included in the stream by using the decoding key generated by the key generation means, and outputting the stream including the decoded data.

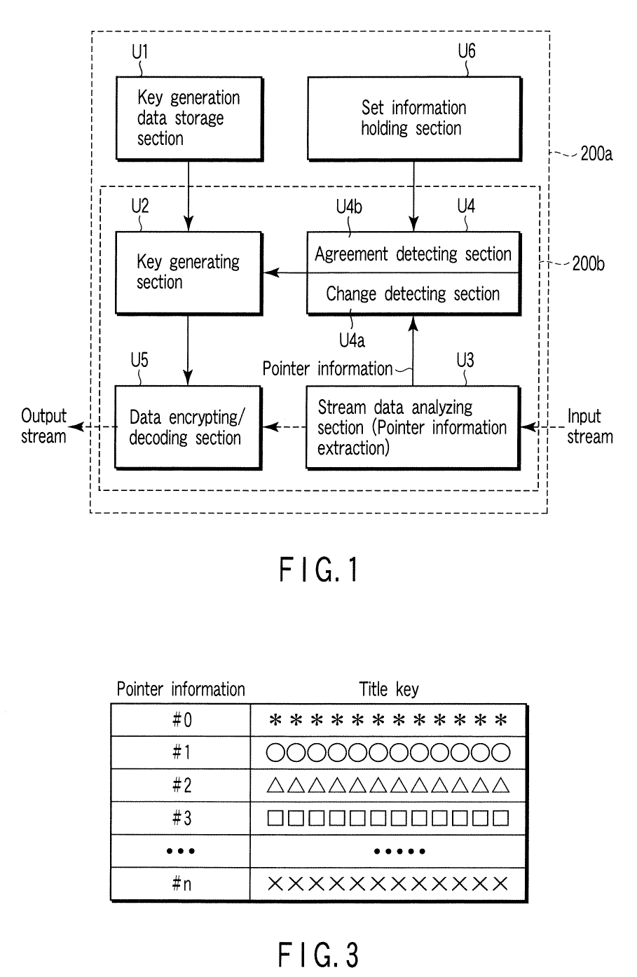

An information processing apparatus and an information processing method according to embodiments of the present invention are explained with reference to drawings. FIG. 1 is a diagram illustrating a configuration of a main part of an information processing apparatus according to an embodiment of the present invention. In the configuration, title key information (title key management data) necessary for generating a decoding key (or an encrypting key) of a title (AV content) included in an input stream is stored in a key generation data storage section U1. The title key information stored in the storage section U1 is processed by a key generating section U2, and thereby a title key is generated.

The input stream has a header portion (sector header) which is not encrypted. The header portion is analyzed by a stream data analyzing section U3. The analyzing section U3 extracts pointer information in the header portion. A set information holding section U6 holds set information corresponding to the pointer information of the stream to be input. The set information is used for detecting whether the pointer information in the stream cannot be used due to corruption or the like (details thereof is described later).

The pointer information extracted by the analyzing section U3 is temporarily stored in a register (not shown) or the like, and compared with previously-extracted pointer information (configured to also be temporarily stored in a register not shown). By this comparison, change of the pointer information is detected. (For example, suppose that the identifier of the previously-extracted pointer information is #n−1 and the identifier of the currently extracted pointer information is #n. Since the identifier has been changed from #n−1 to #n, change of the pointer information is detected.) Change of the pointer information is detected by the change detecting section U4a.

Further, the pointer information after change is compared with the predetermined set information held in the set information holding section U6, and it is detected whether the pointer information agrees with (or corresponds to) the set information. An agreement detecting circuit U4b performs detection of agreement. Further, if an agreement condition is predetermined that the pointer information #n corresponds to the set information #N, agreement can be detected when #n corresponds to 4N as a result of comparison, even if the #n is different from #N.

A pointer information detecting portion U4 is formed by combination of the above change detecting section U4a and the agreement detecting section U4b. The detecting portion U4 outputs pointer information when the change detecting section U4a detects change and the agreement detecting section U4b detects agreement (or correspondence) of the pointer information with the predetermined set information. The output pointer information serves as a trigger, and thereby the key generating section U2 generates the title key.

The title key generated by the key generating section U2 with the pointer information from the detecting section U4 used as trigger is supplied to the data encrypting/decoding section U5. The data encrypting/decoding section U5 decodes (or encrypts) data following the extracted pointer information, using the title key as a decoding key (or an encrypting key), and outputs the decoded (or encrypted) stream.

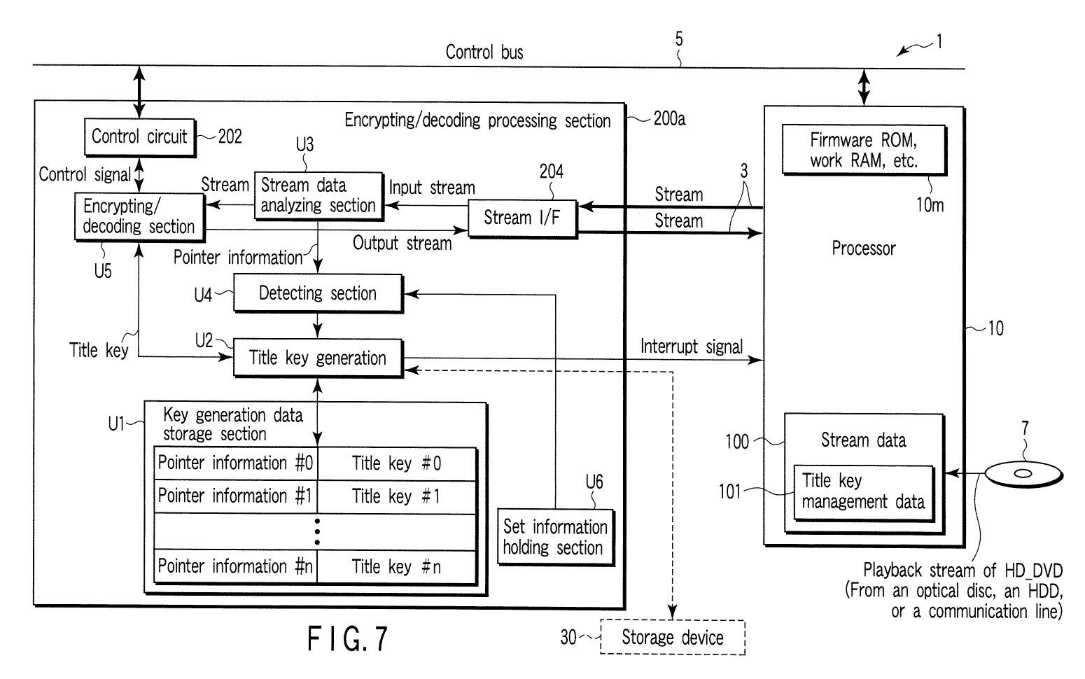

In the configuration of FIG. 1, although the whole (U1 to U6) processing section 200a may be formed of a dedicated LSI, a part (U2 to U5) of the processing section 200c may be formed as an LSI, and other parts (U1 and/or U6) may be provided to other control devices (such as a microcomputer). Specific examples thereof will be described later with reference to FIGS. 7 to 9.

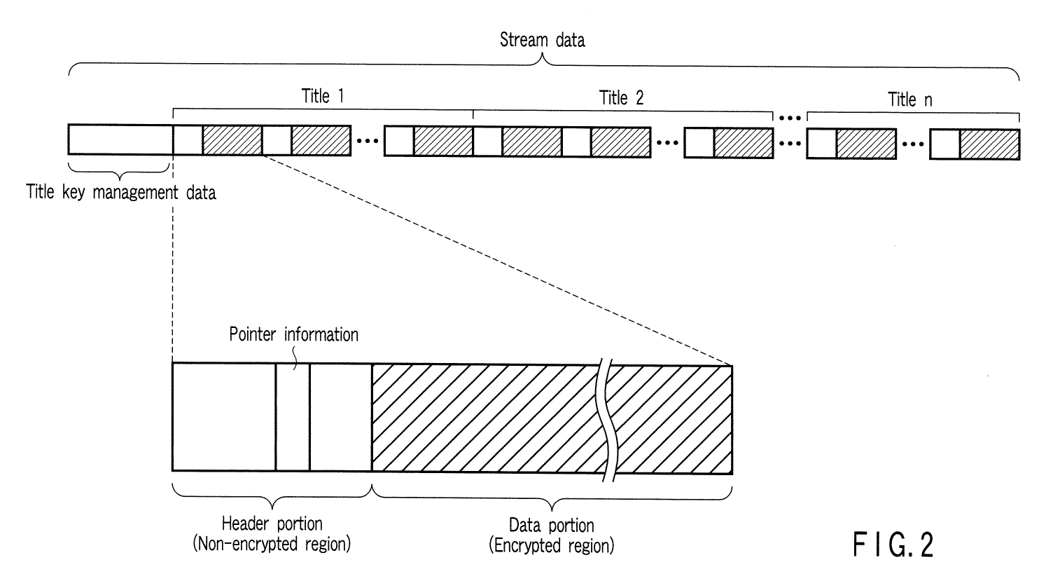

FIG. 2 is a diagram illustrating an example of stream data processed by the configuration of FIG. 1. The stream data includes a plurality of video titles (hi-vision AV content), and can be recorded on a large-capacity disc or the like having recording tracks divided into sectors by using packets. Each title is formed of at least one sector (or packet). The titles may be encrypted by different title keys (key information which is directly or indirectly used for decoding of the stream). A header region (non-encrypted region) in a specific sector of each title includes pointer information indicating a title key corresponding to the title. A data region (encrypted region) is a region which is encrypted or decoded by using the title key indicated by the pointer information.

FIG. 3 is a diagram illustrating an example of title key management data (key generation data) used in the configuration of FIG. 1. The key management data is referred to when generating key information, and recorded on a disc as a title key file. In the example of FIG. 3, title keys of n+1 number (for example, 256 keys) are prepared, and pointer information items (#0 to #n) are assigned to the respective title keys to indicate the respective title keys.

In the example of FIG. 2, the title key file (title key management data) in FIG. 3 is attached to the head of the stream data. The key management data is not limited to a form of accompanying the stream data, but may be provided separately. For example, it is possible to adopt an embodiment in which stream data of titles are recorded on a disc, and the title key management data portion is stored separately (in advance) in a memory (corresponding to U1 of FIG. 1) of the apparatus. In this case, the title key management data of FIG. 2 may not be recorded on the disc.

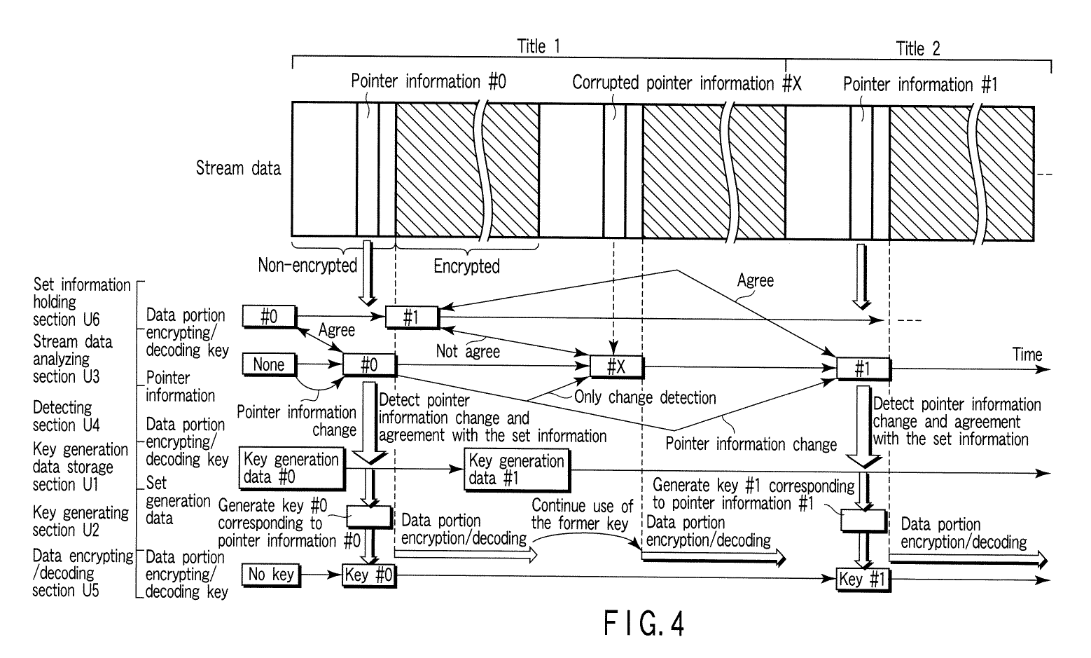

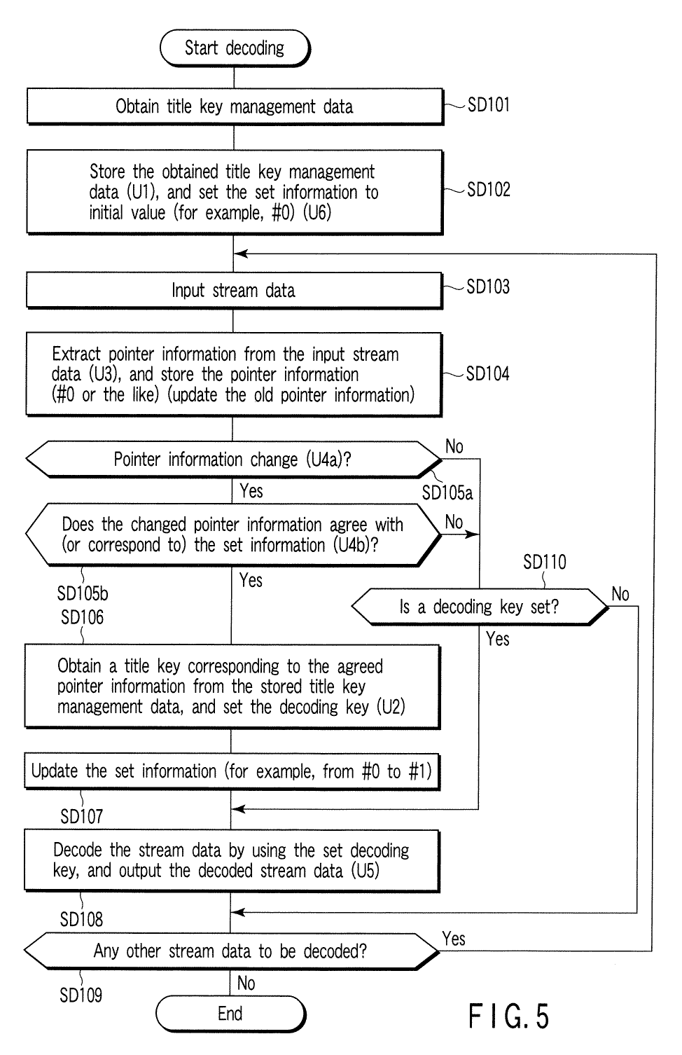

FIG. 4 is a time chart illustrating an example of a flow of decoding (or encryption) executed by the configuration of FIG. 1. First, suppose that the key generation data storage section U1 holds information (FIG. 3) for generating a title key necessary for decoding (or encryption) of a title. Further, suppose that predetermined set information (with an initial value of #0 in this example) for detecting agreement of pointer information is set in the set information holding section U6.

Directly after input of stream data, the stream data analyzing section U3 has detected no pointer information. When first pointer information #0 of title 1 is detected from the input stream data, the pointer information changes from the initial state “None” (or “a value which cannot be indicated by the pointer” held before) to “#0”. The pointer information #0 after the change is compared with the set information #0 held in the set information holding section U6. Since the pointer information has changed and the pointer information #0 after the change agrees with (or corresponds to) the set information #0, the detecting section U4 determines that normal pointer information #0 is detected. The key generating section U2 is notified of the detection result. The key generating section U2 notified thereof receives a corresponding title key information item from the key generation data storage section U1, and generates a title key by processing the title key information item. The data encrypting/decoding section U5 decodes (or encrypts) the data portion of the stream, by using the title key generated by the key generating section U2.

Specifically, with detection of change and agreement of the pointer information used as a trigger, the title key #0 corresponding to the detected pointer information #0 is generated by the key generating section U2, with reference to the title key file (title key management data) in the key generation data storage section U1. As a result of the generation, the set information set in the set information holding section U6 is updated (for example, from #0 to #1). The updated set value (#1) is held therein until a next title key is generated. The data encrypting/decoding section U5 decodes (or encrypts) the data of the encrypted region following the detected pointer information #0, by using the generated key #0.

When decoding (or encryption) using the key #0 ends and the pointer information changes, suppose that the pointer information after the change is corrupted to be corrupted pointer information #X, not the normal pointer information #1. In this case, even if change of the pointer information (from #0 to #X) is detected, the pointer information #X after the change does not agree with the set information #1 held in the set information holding section U6. In this case, since it is impossible to use a key corresponding to the false pointer information #X (or such a key does not exist in the key generation data storage section U1), the former key #0 is used for decoding (or encryption) of data following the corrupted pointer information #X (if the data following the corrupted pointer information is encrypted by the former key, the former key can be used for decoding the data following the corrupted pointer information).

When decoding (or encryption) of the title 1 using the former key #0 ends and the pointer information changes, suppose that the pointer information after the change is pointer information #1. In this case, the pointer information #1 detected after the change agrees with the set information #1 held in the set information holding section U6. Therefore, since the pointer information has changed and the pointer information #1 after the change agrees with (or corresponds to) the set information #1, the detecting section U4 determines that normal pointer information #1 has been detected. The key generating section U2 is notified of the detection result. The key generating section U2 notified thereof receives a corresponding title key information item from the key generation data storage section U1, and generates a title key by processing the title key information item. The data encrypting/decoding section U5 decodes (or encrypts) the data portion of the stream of the title 2, by using the title key generated by the key generating section U2. Thereafter, the same operation as the above is repeatedly continued until the stream data ends (or the processing is intentionally ended).

If there is no fear that the pointer information is not corrupted, a title key can be generated only by detecting change of the pointer information. However, if there is corrupted pointer information #X (which can actually occur) as illustrated in FIG. 4, the apparatus undesirably detects the corrupted pointer information as change. Therefore, a false title key is generated for stream data to be processed next, and the stream is decoded (or encrypted) by using the false title key. This causes difference in correspondence between the stream data and the title. In the configuration illustrated in FIG. 1, if the changed pointer information does not agree with the set information set separately, a title key is not generated, and the processing is continued by using the title key currently used. This structure prevents occurrence of the above difference.

FIG. 5 is a flowchart illustrating an example of decoding executed by the configuration of FIG. 1. First, title key management data (FIG. 3) for the stream data to be decoded is obtained from a disc or the like (SD101) (this obtaining step is unnecessary if information corresponding to the title key management data is stored in the key generation data storage section U1 in advance). The obtained title key management data is stored in the key management data storage section U1, and the set information holding section U6 is set to an initial value (for example, #0) (SD102). Then, stream data to be decoded is input (SD103). The stream data analyzing section U3 extracts pointer information from a non-encrypted region of the input stream data, and stores the extracted pointer information (for example, pointer information #0) (If the old pointer information already exists in the storage area, the old pointer information is updated to the new pointer information. However, the old pointer information is temporarily stored in a register or the like until the next pointer information change detection is ended) (SD104).

If the old pointer information is not #0 and the new pointer information is #0, it is determined that the pointer information has changed (Yes of SD105a). This change is detected by the change detecting section U4a. If the changed pointer information #0 agrees with (or corresponds to) the set information #0 of the set information holding section U6 (Yes of SD105b), the key generating section U2 obtains a title key #0 (for example, “************” of FIG. 3) corresponding to the agreed pointer information #0 from the key generation data storage section U1, processes the obtained title key (decoding key in this processing), and sets the key in the data decoding section U5 (SD106). Then, the set information held in the set information holding section U6 is updated to #1 (SD107). The data decoding section U5 decodes data of the encrypted region of the input stream data by using the title key #0 corresponding to the pointer information #0, and outputs the decoded stream data (SD108).

If there is any other stream data to be decoded (Yes of SD109), the apparatus returns to SD103. Then, the following stream data is input (SD103). Then, the stream data analyzing section U3 extracts pointer information from the non-encrypted region of the input stream data, and stores the extracted pointer information (for example, #X) (although the old pointer information in the storage area is updated to the new pointer information #X, the old pointer information #0 is temporarily stored in a register or the like until next pointer information change detection is ended) (SD104).

If the old pointer information is #0 and the new pointer information is #X, it is determined that there is change of the pointer information (Yes of SD105a). This change is detected by the change detecting section U4a. The changed pointer information #X does not agree with (or correspond to) the set information #1 of the set information holding section U6 (No of SD105b), and thus the key generating section U2 does not generate a new decoding key. In this case, if the former decoding key (title key #0) is set (Yes of SD110), the data decoding section U5 decodes data of the encrypted region of the input stream data by using the decoding key (title key #0), and outputs the decoded stream data (SD108).

For example, when output of the stream data of title 1 is ended, the apparatus of FIG. 1 makes an interrupt on the processor (microcomputer) which controls the processing of FIG. 5, to inquire whether there is any other stream data (for example, title 2) to be processed. As a result, if there is any other stream data to be decoded (Yes of SD109), the apparatus returns to SD103. Then, the following stream data is input (SD103). While no new pointer information is detected and thus the pointer information is not changed (No of SD105a), the data decoding section U5 decodes data of the encrypted region of the input stream data by using the decoding key (title key #0), and outputs the decoded stream data (SD108), as long as the decoding key (title key #0) is set (Yes of SD110).

IF no decoding key (title key) is set (No of SD110), a processing loop of SD103, SD104, SD105a/SD105b, SD110, and SD109 is repeated, until the pointer information changes (Yes of SD105a) and the changed pointer information agrees with (or corresponds to) the predetermined set information (Yes of SD105b) and a decoding key (title key) is set (SD106). If no pointer information change or agreement with the set information is detected to the last of the stream data and a state in which no decoding key is set continues to the last, the processing of FIG. 5 is ended as an error (or the processing is ended by outputting the input stream without decoding).

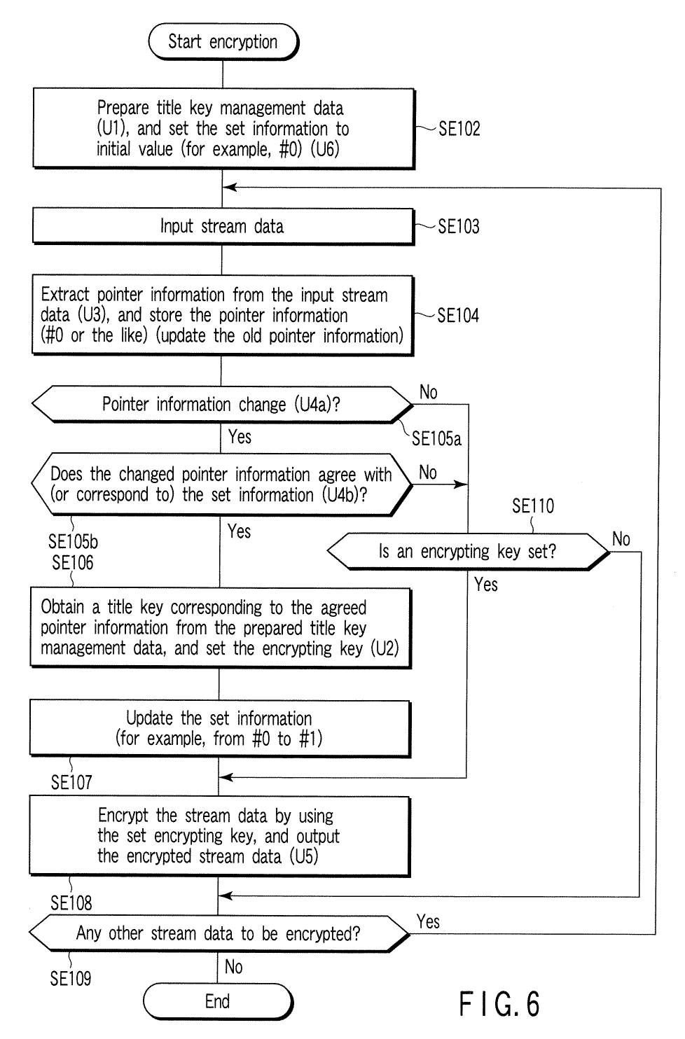

FIG. 6 is a flowchart illustrating an example of encryption executed by the configuration of FIG. 1. First, title key management data (FIG. 3) for stream data to be encrypted is prepared, and the set information holding section U6 is set to an initial value (for example, #0) (SE102). The prepared title key management data is stored in the key generation data storage section U1 until all the encryption is ended. Then, stream data to be encrypted is input (SE103). The stream data analyzing section U3 extracts pointer information from a non-encrypted region of the input stream data, and stores the extracted pointer information (for example, pointer information #0) (If the old pointer information already exists in the storage area, the old pointer information is updated to the new pointer information. However, the old pointer information is temporarily stored in a register or the like until the next pointer information change detection is ended) (SE104).

If the old pointer information is not #0 and the new pointer information is #0, it is determined that the pointer information has changed (Yes of SE105a). This change is detected by the change detecting section U4a. If the changed pointer information #0 agrees with (or corresponds to) the set information #0 of the set information holding section U6 (Yes of SE105b), the key generating section U2 obtains a title key #0 (for example, “********* ” of FIG. 3) corresponding to the agreed pointer information #0 from the key generation data storage section U1, processes the obtained title key (encrypting key in this processing), and sets it in the data encrypting section U5 (SE106). Then, the set information held in the set information holding section U6 is updated to #1 (SE107). The data encrypting section U5 encrypts data of the encrypted region of the input stream data by using the title key #0 corresponding to the pointer information #0, and outputs the encrypted stream data (SE108).

If there is any other stream data to be encrypted (Yes of SE109), the apparatus returns to SE103. Then, the following stream data is input (SE103). Then, the stream data analyzing section U3 extracts pointer information from the non-encrypted region of the input stream data, and stores the extracted pointer information (for example, #X) (although the old pointer information in the storage area is updated to the new pointer information #X, the old pointer information #0 is temporarily stored in a register or the like until next pointer information change detection is ended) (SE104).

If the old pointer information is #0 and the new pointer information is #X, it is determined that there is change of the pointer information (Yes of SE105a). This change is detected by the change detecting section U4a. The changed pointer information #X does not agree with (or correspond to) the set information #1 of the set information holding section U6 (No of SE105b), and thus the key generating section U2 does not generate a new encrypting key. In this case, if the former encrypting key (title key #0) is set (Yes of SE110), the data encrypting section U5 encrypts data of the encrypted region of the input stream data by using the encrypting key (title key #0), and outputs the encrypted stream data (SE108).

For example, when output of the stream data of title 1 is ended, the apparatus of FIG. 1 makes an interrupt on the processor (microcomputer) which controls the processing of FIG. 6, to inquire whether there is any other stream data (for example, title 2) to be processed. As a result, if there is any other stream data to be encrypted (Yes of SE109), the apparatus returns to SE103. Then, the following stream data is input (SE103). While no new pointer information is detected and thus the pointer information is not changed (No of SE105a), the data encrypting section U5 encrypts data of the encrypted region of the input stream data by using the encrypting key (title key #0), and outputs the encrypted stream data (SE108), as long as the encrypting key (title key #0) is set (Yes of SE110).

If no encrypting key (title key) is set (No of SE110), a processing loop of SE103, SE104, SE105a/SE105b, SE110, and SE109 is repeated, until the pointer information changes (Yes of SE105a), the changed pointer information agrees with (or corresponds to) the predetermined set information (Yes of SE105b) and an encrypting key (title key) is set (SE106). If no pointer information change or agreement with the set information is detected to the last of the stream data and a state in which no encrypting key is set continues to the last, the processing of FIG. 6 is ended as an error (or the processing is ended by outputting the input stream without encrypting).

FIG. 7 is a diagram illustrating an example of an information processing apparatus (for example, a disc playback apparatus) 1, in which an LSI having the configuration (encryption/decoding processing section 200a) of FIG. 1 is incorporated. A processor 10 of the apparatus 1 includes a memory 10m including a ROM, in which firmware corresponding to a part of or the whole processing illustrated in FIG. 5 and/or FIG. 6 is written, and a RAM which provides a work area used for the processing. Although not shown in FIG. 7, the apparatus 1 can include an optical disc drive using blue laser, a hard disc drive, and a communication interface, etc.

The playback apparatus 1 comprises the processor 10, an encryption/decoding processing section 200a, and (if necessary) a storage device 30. The processor 10 has a function of reading moving image stream data (for example, MPEG2-PS) 100 transmitted from a medium (an optical disc, a hard disc, a communication line) 7. The moving image stream data 100 recorded on the medium 7 comprises one or more titles. Each title comprises pointer information, and encrypted data which is decoded by a decoding key corresponding to the pointer information. The moving image stream data 100 includes title key management data 101 (corresponding to FIG. 3), which is formed of combinations of pointer information items of the moving image stream data 100 and decoding keys corresponding to the respective pointer information items.

The processor 10 reads the moving image stream data 100 recorded on the medium 7, and plays back the decoded moving image stream data output from the encrypting/decoding processing section 200a. The processor 10 transmits the title key management data 101 included in the read moving image stream data 100 to the encrypting/decoding processing section 200a through a control bus 5. Further, the processor 10 transmits the read moving image stream data 100 to the encrypting/decoding processing section 200a through a data bus 3. Furthermore, the processor 10 determines whether there is moving image stream data to be played back, which is to be transmitted next, in response to an interruption signal from the encrypting/decoding processing section 200a. If it determines that there is moving image stream data to be played back and to be transmitted next, the processor 10 transmits the moving image stream data to be played back to the encrypting/decoding processing section 200a.

The encrypting/decoding processing section 200a comprises a control circuit 202, an encrypting/decoding section US, a stream interface (I/F) 204, a pointer information change/agreement detecting section U4, a stream data analyzing section U3, a title key generating section U2 and a key generation data storage section U1, and a set information holding section U6. The control circuit 202 controls the components of the encrypting/decoding processing section 200a. The control circuit 202 has a function of controlling operation of the encrypting/decoding section U5 by control signals. The control circuit 202 also performs storing of the title key management data 101, input from the processor 10 through the control bus 5, in the storage section U1. Further, the control circuit 202 has a function of storing the title key management data 101 input from the processor 10 through the control bus 5 in the nonvolatile storage device 30 (if necessary). The title key generating section U2 also has a function of communicating with the storage device 30.

The key generation data storage section U1 is formed of, for example, a nonvolatile memory (for example EEPROM, battery-protected SRAM), and stores the transmitted title key management data 101 by control by the control circuit 202. The storage device 30 is selectively provided (if necessary) on the playback apparatus 1. The storage device 30 is also configured to store the transmitted title key management data 101.

The encrypting/decoding section U5 has a function of decoding the moving image stream data input from the stream data analyzing section U3, by using the title key set in the register (not shown) in the encrypting/decoding section U5. Further, the encrypting/decoding section U5 transmits the decoded moving image stream data 100 to the stream I/F 204. Further, the encrypting/decoding section U5 sets the title key transmitted from the title key generating section U2 in place of the title key set in the register of the encrypting/decoding section U5 (update of the title key). The stream I/F 204 is an interface which transmits the moving image stream 100, transmitted from the processor 10 through the bus 3, to the stream data analyzing section U3. The stream I/F 204 also transmits the decoded moving image stream data input from the encrypting/decoding section U5 to the processor 10 through the bus 3.

The detecting section U4 connected to the stream data analyzing section U3 detects whether the pointer information included in the moving image stream data 100 input from the stream I/F 204 has changed or not, and extracts the changed pointer information. The detecting section U4 further checks whether the changed pointer information agrees with (or corresponds to) the set information from the set information holding section U6. If change of the pointer information is detected and the changed pointer information agrees with (or corresponds to) the set information, the detecting section U4 transmits the detected pointer information to the title key generating section U2. The title key generating section U2 obtains, from the key generation data storage section U1, a title key corresponding to the pointer information transmitted from the detecting section U4, and transmits the obtained title key to the encrypting/decoding section U5. Specifically, the title key generating section U2 transmits the title key (decoding key) indicated by the pointer information, with which change and agreement are detected, to the encrypting/decoding section U5. Further, the title key generating section U2 can be configured to transmit an interruption signal, which indicates transmission of a title key to the encrypting/decoding section U5, to the processor 10 when it transmits the title key to the encrypting/decoding section U5.

When the information processing apparatus (playback apparatus) 1 reads a medium 7 such as a large-capacity optical disc and an HDD, the information processing apparatus 1 first reads decoding key management data (corresponding to FIG. 3) included in the stream data recorded on the medium 7, and stores the read decoding key management data in, for example, the storage device (the key generation data storage section U1) in the playback apparatus 1. Next, the processing section 200a of the playback apparatus 1 detects change of the pointer information included in the moving image stream data recorded on the medium 7, obtains a title key corresponding to the detected pointer information from the decoding key management data stored in the storage device U1, and executes decoding of the input moving image stream by using the obtained title key. If the processing section 200a does not detect any change of the pointer information included in the moving image stream data recorded on the medium 7, the processing section 200a executes decoding of the input moving image stream data by using the title key obtained in the previous processing.

In the example illustrated in FIG. 7, the key generation data storage section U1 and the set information holding section U6 are located in the processing section 200a. Therefore, transmission/reception of the set information and the key generation data can be completed for a short time, and thus decoding or encryption can be quickly performed.

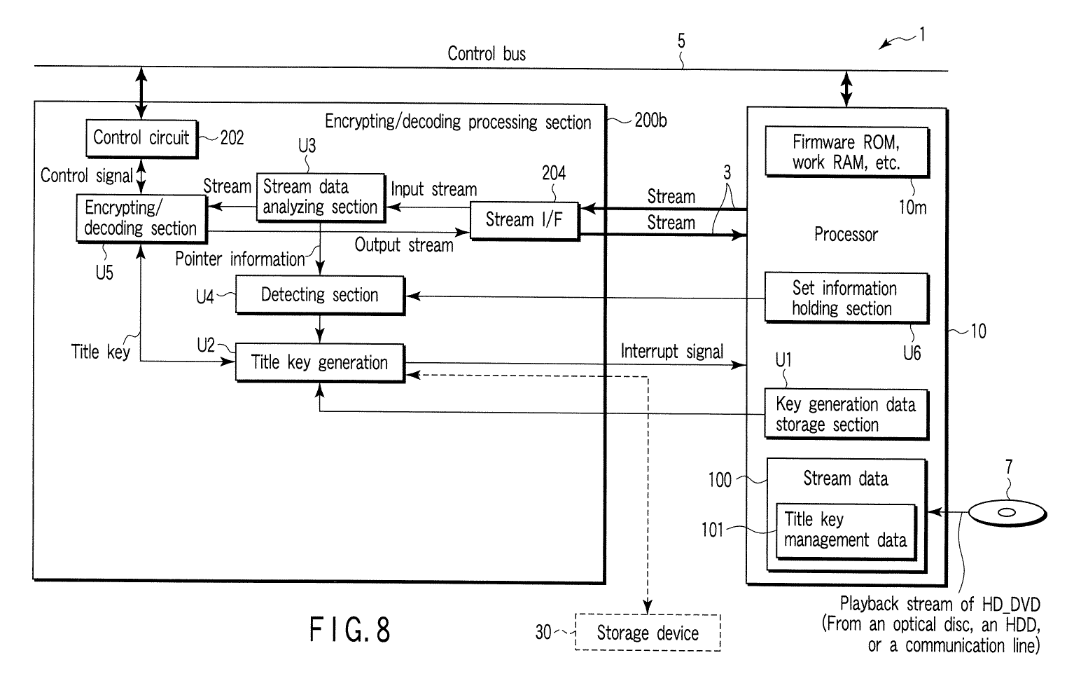

FIG. 8 is a diagram illustrating another example of the information processing apparatus in which the configuration (processing section 200b) of FIG. 1 is incorporated. FIG. 8 can be regarded as a modification of the example of FIG. 7. The example of FIG. 7 has a structure in which the key generation data storage section U1 and the set information holding section U6 are incorporated (for example, as mask ROM data or EEPROM data) in the LSI of the processing section 200a. In the example of FIG. 8, the key generation data storage section U1 and the set information holding section U6 are incorporated in the processor 10 (as rewritable EEPROM or battery-protected SRAM data).

In the example of FIG. 8, the key generation data storage section U1 and the set information holding section U6 are located in the processor 10. Therefore, it is necessary to transmit the set information and the key generation data to the processing section 200a through the bus, each time the key is updated. Generally, the data transmission rate between LSIs via a bus is lower than the data transmission rate within one LSI, and thus the example of FIG. 8 has disadvantage in comparison with the example of FIG. 7 in terms of the processing speed. However, this disadvantage can be overcome in practical use, as long as the processing speed of the processor 10 and the transmission rate of the bus are sufficiently high.

Although the example of FIG. 8 has disadvantage in terms of the processing speed, it also has an advantage since the processor 10 includes the key generation data holding section U1 and the set information holding section U6. The advantage of the example of FIG. 8 is that the key generation data (the title key file in FIG. 3) and/or the set information can be quickly and easily rewritten by software. Specifically, even after the player (or the recorder) having the configuration of FIG. 8 has been sold and possessed by the user, the set manufacturer or the content provider can change the data of the key generation data storage section U1 and/or the set information holding section U6, through the telephone lines or communication lines such as digital broadcasting.

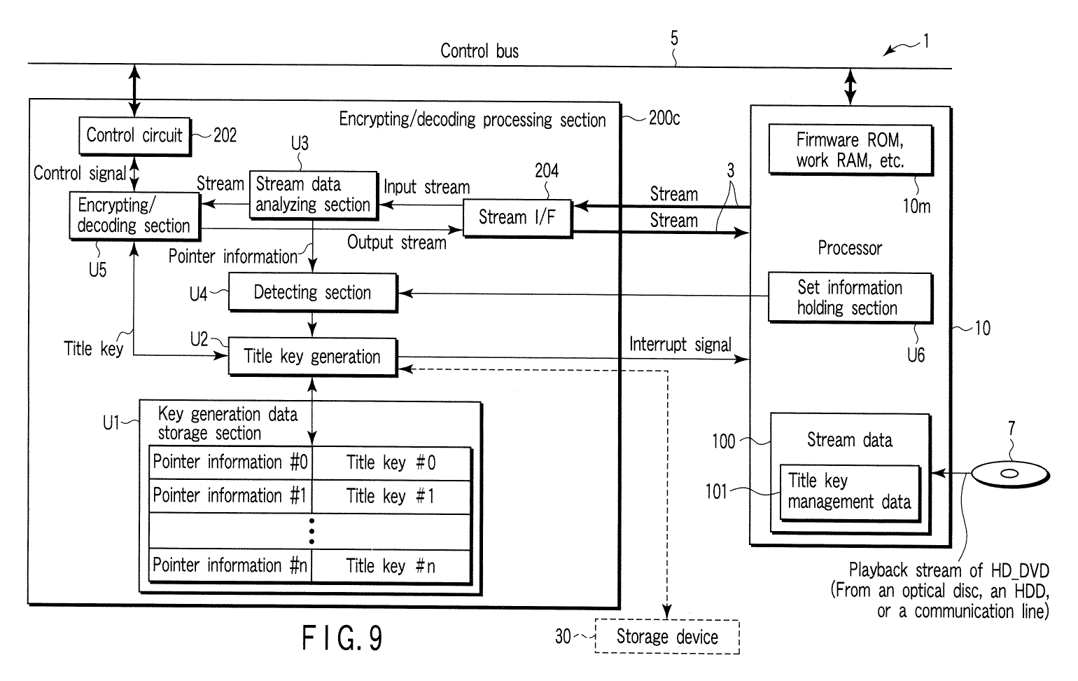

FIG. 9 is a diagram illustrating another example of the information processing apparatus in which the configuration of FIG. 1 is incorporated. FIG. 9 can also be regarded as a modification of the example of FIG. 8. Specifically, the example of FIG. 8 has a structure in which both the key generation data storage section U1 and the set information holding section U6 are provided on the processor 10, while the example of FIG. 9 has a structure in which only the set information holding section U6 is provided on the processor 10. (Although not shown, it is possible to adopt a structure in which the key generation data storage section U1 is provided on the processor 10, and the set information holding section U6 is provided on the encrypting/decoding processing section 200c.)

In the example of FIG. 9, the key generation data storage section U1 with relatively much information quantity is disposed on the processing section 200c to avoid disadvantage in speed, while the set information holding section U6 with relatively little information quantity is disposed on the processor 10 to provide an environment in which the set information can be easily changed by software (for example, from the outside through a communication line). (If the set information is changed after encryption of the stream data, gap occurs in the correspondence between the stream data and the title in decoding, and the encrypted content cannot be normally played back. However, this “gap” may be used for viewing control of the content.)

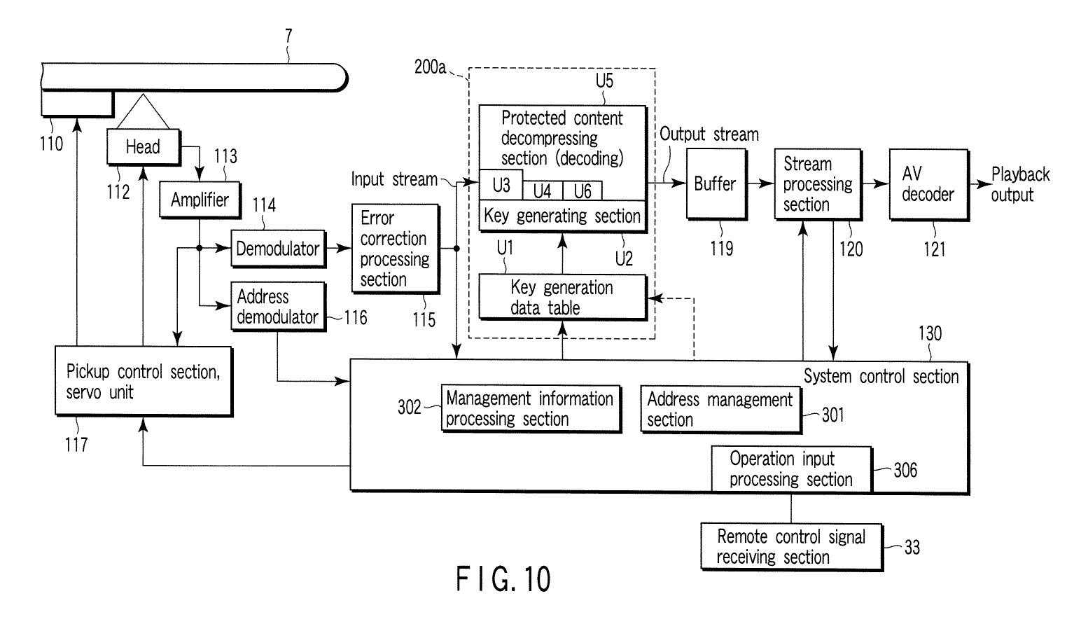

FIG. 10 is a diagram illustrating an example of an optical disc playback apparatus in which the configuration of FIG. 1 is incorporated. An optical disc (DVD) 7 is rotated and driven by a disc motor 110. Information recorded on the optical disc 7 is read by an optical head 112, converted into an electric signal and input to an amplifier 113. The output of the amplifier 113 is input to a pickup control section and servo unit 117, and input to a demodulator 114 and an address demodulating section 116.

The pickup control section and servo unit 117 generates a focus error signal and a tracking error signal and the like by using the output of the amplifier 113, and controls an actuator of the optical head 112 to control focus and tracking. Further, the pickup control section and servo unit 117 controls to stabilize rotation of the disc motor 110.

The demodulator 114 demodulates a playback signal binarized by a binary circuit (not shown). This demodulating converts a signal from 16 bytes to 8 bytes, using a conversion table. The demodulated signal is input to an error connection processing section 115 to correct an error. The address demodulating section 116 reads a physical address from the playback signal. The read address is taken in a system control section 130, and managed by an address management section 301.

The system control section 130 can also control the movement position of the optical head 112 through the pickup control section and servo unit 117. Further, the system control section 130 also sets a rotation number of the disc motor 110.

In the demodulated signal which has been error-corrected by the error correction processing section 115, management information such as information of a file system is input to a management information processing section 302 of the system control section 130. Further, key data being a part of the management information is written in a key generation data table U1. The key generation data table U1 may be a semiconductor memory prepared as a secondary memory, or a hard disk (not shown) contained in the apparatus. If the key data recorded on the disc is encrypted, it is decoded during processing, and then written in the key generation data table U1.

In the demodulated signal from the error correction processing section 115, content (encrypted data or non-encrypted data) is supplied to a protected content decompressing section (decoding section) U5. The protected content decompressing section U5 is provided with a register which stores two key data items, that is, a key generating section U2. The protected content decompressing section U5 decodes the input encrypted content by using the key data. If the input content is not encrypted, the content passes through the protected content decompressing section US under control of the system control section 130.

The content output from the protected content decompressing section U5 is input to a stream processing section 120 through a buffer 119. The stream processing section 120 separates the content into a video packet, an audio packet a sub-image packet, and a control packet including navigation data and the like. The control packet including navigation data is taken in the system control section 130, and managed by the management information processing section 302.

Further, the video packet, the audio packet, and the sub-image packet are input to an AV decoder 121, and subjected to decoding. The sub-image packet includes data such as subtitles, and superposed on the video signal after decoding.

Next, the system control section 130 is explained. The system control section 130 is connected with a remote control signal receiving section 33 which controls operation of the apparatus. Signals received by the remote control signal receiving section 33 are recognized by the operation input processing section 306. The address management section 301 recognizes physical addresses, and manages logical addresses included in the navigation data. The management information processing section 302 manages management information such as file system, and also manages management information transmitted as navigation data, such as attribute information.

In the configuration of FIG. 10, the circuit block 200a, including the key generation data table U1, the key generating section U2 and the protected content decompressing section U5 corresponds to the processing section 200a of FIG. 1. Decoding operation in the circuit block 200a of FIG. 10 is the same as the operation explained above with reference to FIGS. 4 and 5.

The configuration corresponding to one of FIG. 1 and FIGS. 7 to 10 can also be incorporated in recorders having a recording and playback function, as well as playback-only players. Specifically, the present invention is available in players and/or recorders (in particular, next-generation optical disc players/recorders required to perform high-grade copy management/copyright management).

Further, the present invention is also available in general-purpose information processing apparatuses, such as personal computers equipped with an optical disc drive and/or hard disc drive which record stream data used in the configuration of one of FIGS. 1 and FIGS. 7 to 10, and with software corresponding to the processing of FIG. 5 and/or FIG. 6.

<Conclusion of Embodiments and Advantages Thereof>

The above embodiments disclose the encrypting and decoding method of stream data including pointer information designating a key used for encryption/decoding of the stream data in a non-encrypted region of the stream data, wherein encrypting/decoding keys of the stream data are generated in encrypting/decoding of the stream data, by using, as a trigger, agreement between detection of change of the pointer information and the pointer information of stream data as a processing object set separately.

Unlike the above embodiments, supposing that a decoding key is generated only by detection of change of the pointer information, if the pointer information is corrupted, a decoding key is generated by a trigger of generation of a false key in decoding of stream data, and all the following stream data is decoded by a false decoding key. In comparison with this, the present invention generates a decoding key by using change and agreement of the pointer information as a trigger. Therefore, even if the pointer information is corrupted, normal decoding can be performed.

The present invention is not limited to the above embodiments, but can be variously modified within the range not departing the gist of the invention, based on technique available in current or future carrying out of the invention. For example, the encrypting method available in the present invention is not only CSS (Content Scramble System) referred to in the section “Background of the Invention”, but also AES (Advances Encryption Standard) being a stronger encryption method. The gist of the present invention resides in how to generate a decoding key or an encrypting key, and the present invention can be performed regardless of the decoding/encrypting method itself. Therefore, encrypting methods other than CSS and AES can be adopted.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus having a processing section, the processing section decoding a stream including non-encrypted pointer information and encrypted data to be decoded by key information designated by the pointer information, the information processing apparatus comprising:
holding means for holding predetermined set information corresponding to the pointer information of the stream to be input; and
storage means for storing key generation data formed of a combination of the pointer information included in the stream and the key information designated by the pointer information,
wherein the processing section includes:
extracting means for extracting the pointer information included in the input stream;
first detecting means for detecting change of the pointer information extracted by the extracting means;
second detecting means for detecting that the pointer information, change of which has been detected by the first detecting means, agrees with or corresponds to the set information corresponding to the changed pointer information and held in the holding means;
key generation means for obtaining key information corresponding to the pointer information included in the input stream from the key generation data stored in the storage means, and generating a decoding key, when the second detecting means detects agreement or correspondence between the pointer information and the set information; and
decoding means for detecting the encrypted data included in the stream by using the decoding key generated by the key generation means, and outputting the stream including the decoded data.

2. An information processing apparatus according to claim 1, wherein
if the first detecting means detect change of the pointer information, the second detecting means does not detect the agreement or correspondence and there is the decoding key generated before the detection, the decoding means decodes the encrypted data by using the decoding key.

3. An information processing apparatus according to claim 1, wherein the processing section is provided with at least one of the holding means for holding the predetermined set information and the storage means for storing the key generation data.

4. An information processing apparatus according to claim 1, further comprising:
a processor which controls operation of the processing section,
wherein at least one of the holding means for holding the predetermined set information and the storage means for storing the key generation data is provided in the processor.

5. An information processing apparatus according to claim 1, further comprising
a reading device which reads the pointer information and the encrypted data from an information storage medium storing the stream.

6. An information processing apparatus having a processing section, the processing section generating a stream including non-encrypted pointer information and data to be encrypted by key information designated by the pointer information, the information processing apparatus comprising:
holding means for holding predetermined set information corresponding to the pointer information of the stream to be input; and
storage means for storing key generation data formed of a combination of the pointer information included in the stream and the key information designated by the pointer information,
wherein the processing section includes:
extracting means for extracting the pointer information included in the input stream;
first detecting means for detecting change of the pointer information extracted by the extracting means;
second detecting means for detecting that the pointer information, change of which has been detected by the first detecting means, agrees with or corresponds to the set information corresponding to the changed pointer information and held in the holding means;
key generation means for obtaining key information corresponding to the pointer information included in the input stream from the key generation data stored in the storage means, and generating an encrypting key, when the second detecting means detects agreement or correspondence between the pointer information and the set information; and
encrypting means for encrypting the data included in the stream by using the encrypting key generated by the key generation means, and outputting the stream including the encrypted data.

7. A method of decoding a stream including non-encrypted pointer information and encrypted data to be decoded by key information designated by the pointer information, comprising:
storing key generation data formed of a combination of the pointer information included in the stream and the key information designated by the pointer information, and setting predetermined set information corresponding to the pointer information of the stream to be input;
extracting the pointer information included in the input stream;
detecting change of the extracted pointer information;
detecting that the pointer information, change of which has been detected, agrees with or corresponds to the set information corresponding to the changed pointer information;
obtaining key information corresponding to the pointer information included in the input stream from the key generation data, and generating a decoding key, when agreement or correspondence between the pointer information and the set information is detected; and
decoding the encrypted data included in the stream by using the generated decoding key, and outputting the stream including the decoded data.

8. A method according to claim 7, wherein
if change of the pointer information is detected, the agreement or correspondence is not detected and there is the decoding key generated before the detection, the encrypted data is decoded by using the decoding key.

9. A method of generating a stream including non-encrypted pointer information and data to be encrypted by key information designated by the pointer information, comprising:
preparing key generation data formed of a combination of the pointer information included in the stream and the key information designated by the pointer information, and setting predetermined set information corresponding to the pointer information of the stream to be input;
extracting the pointer information included in the input stream;
detecting change of the extracted pointer information;
detecting that the pointer information, change of which has been detected, agrees with or corresponds to the set information corresponding to the changed pointer information;
obtaining key information corresponding to the pointer information included in the input stream from the key generation data, and generating an encrypting key, when agreement or correspondence between the pointer information and the set information is detected; and
encrypting the data included in the stream by using the generated encrypting key, and outputting the stream including the encrypted data.

10. A method according to claim 9, wherein
if change of the pointer information is detected, the agreement or correspondence is not detected and there is the decoding key generated before the detection, the data is encrypted by using the encrypting key.
